(19) United States
(12) Patent Application Publication
(10) Pub. No.: US 2025/0289362 A1
(43) Pub. Date: Sep. 18, 2025

(54) MODULAR RETROFIT SIGNALING PLATFORM

(71) Applicant: Swan Emerson, Inc., FRIDLEY, MN (US)

(72) Inventors: David Swan, Coon Rapids, MN (US); Mike Emerson, Fridley, MN (US)

(73) Assignee: Swan Emerson, Inc., Fridley, MN (US)

(21) Appl. No.: 19/079,392

(22) Filed: Mar. 13, 2025

Related U.S. Application Data
(60) Provisional application No. 63/565,381, filed on Mar. 14, 2024.

(51) Int. Cl. B60Q 1/34; B60Q 1/26

(52) U.S. Cl. CPC B60Q 1/34; B60Q 1/2615; B60Q 2900/10; B60Q 2900/30

(57) ABSTRACT

A wireless turn signaling system for vehicles, particularly utility vehicles, simplifies installation and enhances functionality compared to traditional wired systems. The system comprises a combination switch module with a user-actuated lever and wireless transmitter and at least one remote light module, each featuring a housing, light source, wireless receiver, and control module. The control module activates the light source upon receiving a signal from the combination switch. Notably, the system eliminates the need for a wired harness between the switch and light modules, and the control module is configurable via Over-The-Air (OTA) software updates, enabling continuous improvement and feature enhancements. This innovative architecture provides an intuitive, easily installed, and expandable turn signaling solution.

### RELATED APPLICATIONS

This application claims the benefit of priority to U.S. Provisional Application Ser. No. 63/565,381 entitled “MODULAR RETROFIT SIGNALING PLATFORM” filed on Mar. 14, 2024, which application is hereby incorporated by reference herein in its entirety.

### FIELD

The present inventive subject matter related to the field of vehicle electronics. More specifically, the present inventive subject matter related to signaling and related systems and methods for vehicles.

### BACKGROUND

To date, adding turn signals to utility vehicles like UTVs and golf carts has relied on traditional approaches like those used in automotive applications. This typically involves mechanical switches mounted on the dashboard or console that activate basic wiring harnesses running to front and rear indicator lights. The switches are flipped manually for left or right turns. Hazard light functionality requires another dedicated switch.

These turn signaling kits require carefully wiring switchgear to indicator lights at both ends of the vehicle. The wiring harnesses tend to be complicated and time consuming to install correctly. Operation is also less intuitive than automotive stalk systems since flipping mechanical switches is not as seamless. This often results in owners not using signals properly or avoiding adding them due to complexity. The wireless modular architecture of this new kit aims to solve these existing usage and installation challenges.

### BRIEF DESCRIPTION OF THE DRAWINGS

Embodiments of the inventive subject matter may be best understood by referring to the following description and accompanying drawings, which illustrate such embodiments. In the drawings:

FIG. 1 illustrates a system architecture diagram showing key components of the system on a vehicle, according to various embodiments.

FIG. 2 is a combination switch diagram illustrating the physical controls and internal components, according to various embodiments.

FIG. 3 is a remote module diagram illustrating the components of a remote light module, according to various embodiments.

FIG. 4 is a wireframe mobile app diagram showing the key screens and flows of a mobile app for changing settings and viewing diagnostics, according to various embodiments.

### DESCRIPTION

In the following description, reference is made to the accompanying drawings that form a part hereof, and in which is shown by way of illustration specific embodiments which may be practiced. These embodiments are described in sufficient detail to enable those skilled in the art to practice the present subject matter, and it is to be understood that other embodiments may be utilized and that structural, logical and material changes may be made without departing from the scope of the present subject matter. The following description of example embodiments is, therefore, not to be taken in a limited sense, and the scope of the present invention is defined by the appended claims.

The present invention discloses a novel wireless turn signaling system for utility task vehicles and other equipment. The system comprises a modular wireless architecture including a combination switch control module with wireless transmitter, distributed indicator light modules with wireless receivers, and optional auxiliary modules.

In this approach, the familiar combination switch (e.g. lever operated) module provides intuitive driver controls for turn, hazard and other signaling functions and wirelessly activates the appropriate indicator light modules mounted externally on the vehicle. The light modules provide visible turn/brake indications to surrounding traffic. The wireless modular design simplifies installation, enhances flexibility for equipment manufacturers, and enables expanding capabilities over time. Additional auxiliary modules can also integrate seamlessly to augment functionality. This represents an advance over conventional wired turn signaling kits which require complex vehicle wiring harnesses and modifications. The present invention thus provides an improved user experience, simplified installation, and superior flexibility compared to existing art.

The turn signal kit is designed to bring an easy to use and install signaling system to UTVs, golf carts, and other utility vehicles. The core of the system is a familiar combination switch interface that the driver uses to activate turn signals and hazards, providing an intuitive control method. This combination switch communicates wirelessly with indicator light modules mounted on the vehicle's front, rear, and sides. The modules are software controlled, allowing advanced logic for turn signal operation and diagnostics.

A benefit is simplified installation versus traditional wiring harnesses. The wireless modules can be quickly mounted on the vehicle exterior and linked to the combination switch. Optional modules like trailer wiring harnesses and additional brake lights can also be added seamlessly. This modular approach also enables expanding capabilities over time through software updates and new module offerings.

The combination switch provides a familiar interface that utility vehicle operators already know how to use, making the system intuitive. It replicates the functionality of a standard turn signal stalk in an automotive application.

The modules communicate wirelessly via WiFi, eliminating the need for complex wiring harnesses. The wireless architecture vastly simplifies installation and expands flexibility.

Each light module contains software logic to control its operation. This allows the system to implement turn signal functionality, diagnostics, and other features in software rather than traditional hardware alone. The software is updatable over-the-air (OTA) to enhance capabilities over time. The control module within each remote light module is designed to receive and process Over-The-Air (OTA) software updates. This capability allows for continuous improvement and expansion of the system's functionality without requiring physical access to the modules. According to various embodiments, OTA updates are used to introduce new lighting patterns, enhance diagnostic capabilities, improve wireless communication performance, address potential security vulnerabilities, and integrate new features based on new developments, user feedback or evolving industry standards. The OTA update process ensures that the turn signal system remains up-to-date and adaptable to future needs, providing a long-term value proposition for users.

The modular design and software-defined nature of the system enables new capabilities to be added via additional modules and software updates. The system can evolve over time to support innovative features beyond basic turn signaling. The software-defined nature of the light and accessory modules enables a high degree of configurability and customization. Each module incorporates a control module programmed to execute lighting logic and/or manage accessory functions. This software control allows for flexible adaptation to different vehicle types, user preferences, and evolving regulatory requirements.

For example, light modules can be configured to support various lighting patterns, including standard turn signals, sequential turn signals, strobe effects for hazard lights, and dimming capabilities for use as running lights. The intensity of the light output can also be adjusted via software to optimize visibility in different ambient lighting conditions. Furthermore, the control module can be programmed to implement advanced features such as automatic turn signal cancellation based on vehicle speed or steering angle, and emergency braking alerts that flash the brake lights rapidly to warn following vehicles.

Accessory modules, such as trailer wiring interfaces, can also be configured via software to support different trailer wiring standards and lighting configurations. The software can be updated to accommodate new trailer types or to enable advanced features such as trailer sway control. Additionally, the mobile app interface allows users to customize the behavior of accessory modules, such as adjusting the sensitivity of a backup camera or configuring the output of auxiliary lighting circuits.

The software configurability of the modules provides a flexible platform for adding new features and capabilities over time. Over-The-Air (OTA) updates allow the control modules to be reprogrammed wirelessly, enabling seamless integration of new lighting patterns, accessory functions, and diagnostic features without requiring physical access to the modules.

The wireless architecture and modular design result in a simplified installation with less wiring than traditional kits. This makes the system easier to retrofit onto existing vehicles by reducing integration complexity.

According to various embodiments, to operate the turn signal kit, the driver simply uses the familiar combination switch interface mounted within easy reach, typically on the steering wheel column or center console. Pushing the combination switch lever left or right activates the corresponding turn signal and associated indicator lights. The turn signals feature automatic self-cancellation after a turn is completed. To indicate a lane change, the driver taps the lever left or right and the signals flash 3 times. The hazard lights are activated by pressing a button on the combination switch unit. As the driver operates the combination switch, it wirelessly communicates with the light modules to switch them on and off, providing a seamless experience that matches conventional automotive stalk systems. The combination switch and wireless operation eliminate the need to manually flip switches or operate non-intuitive controls to signal turns.

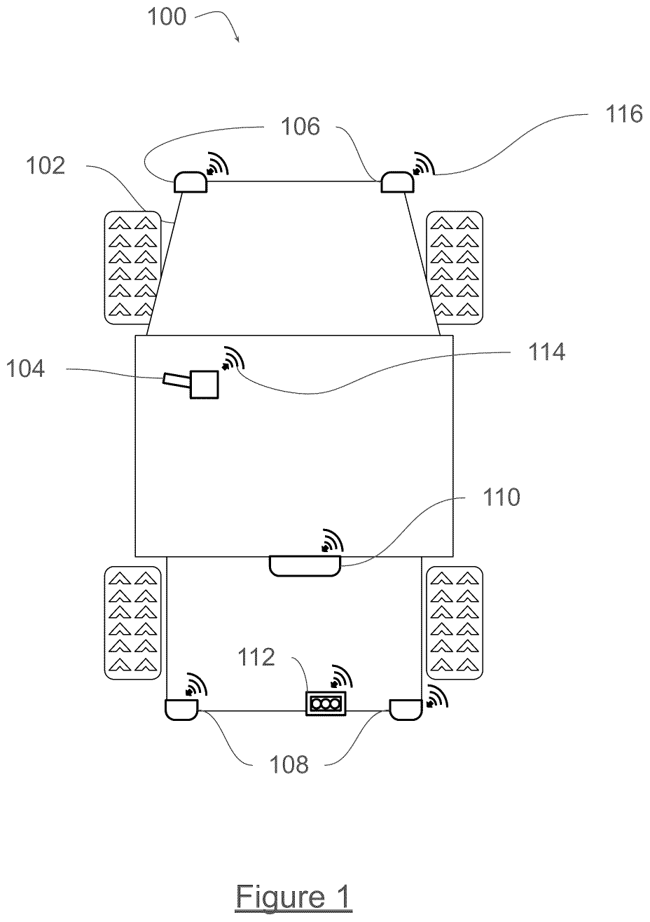

With reference to FIG. 1, example core components of the turn signal system 100 are shown relative to a vehicle 102. The system 100 includes a combination switch 104, front light modules 106, rear light modules 108, a third brake light 110, and trailer connection 112. Each device in the turn signal system 100 utilizes wireless communication between the various devices (104-112). A driver of the vehicle 102 interacts with the system 100 via the combination switch 104, which contains buttons and/or switches to control turn signals in the front light modules 106, turn signals in the rear light modules 108, hazard lights, and other functions. According to some embodiments, the combination switch 104 controls only turn signals, and in other embodiments, the combination switch 104 controls additional functions as well. The combination switch 104 communicates using a wireless transmitter 114 to send control signals to the other components in the system 100.

The front light modules 106 and rear light modules 108 include wireless receivers 116 to get commands from the combination switch 104. These light modules also include circuitry to drive the lights for turn indicating. The wireless architecture eliminates complicated wire runs and wiring harnesses. The combination switch 104 and remote modules can have expandable connectors to integrate additional modules like trailer wiring via a trailer connection 112. Optional modules can also communicate wirelessly to integrate seamlessly with the base system. This modular wireless design enabled simplified installation, usage, and future expandability. The combination switch 104 provides familiar controls while the wireless link to the remote modules creates a unified and expandable signaling and control system.

The wireless architecture of the system 100 eliminates the need to run wiring harnesses between the combination switch 104 and the various modules (e.g. 106, 108, 110 and 112). The modules can be quickly affixed and removable for repair or upgrade. Optional additional modules like trailer connection 112 can also be incorporated at suitable locations on the vehicle. This simplifies installing the system 100, even on existing vehicles. The modularity also enables expanding capabilities by adding new modules over time. The combination switch 104 location keeps controls handy for the driver while the distributed modules provide high visibility signaling to surrounding areas.

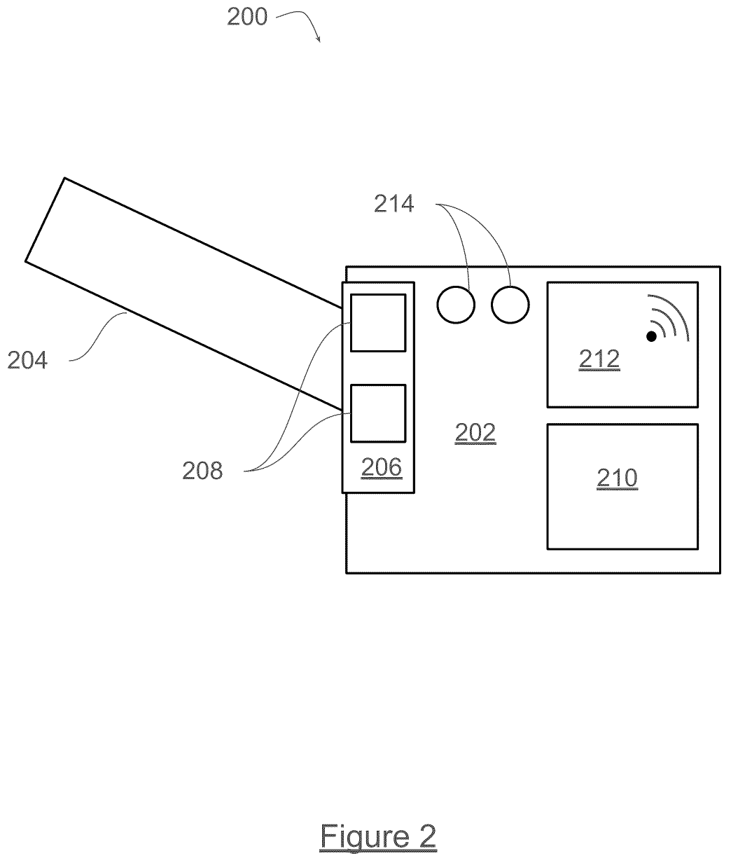

With reference to FIG. 2, a combination switch diagram is provided, illustrating the physical controls and internal components, according to various embodiments. The combination switch module 200 contains the core controls drivers used to operate the turn signaling system. According to various embodiments, the module 200 includes a base 202 having a familiar lever 204 that is pushed directionally (e.g. left/right, up/down) to activate the corresponding turn signals, in a similar fashion to a standard automotive stalk switch. The lever 204 is connected to the base 202 via a switch module 206 which contains the electrical components to process the movement of the lever 204. The lever 204 and switch module 206 combination may include self-canceling functions and different taps may trigger different functionality like lane change signals. Additional controls 208 may be included to drive components like hazard lights or a horn. The additional controls 208 may be located on the base 202 or on the lever 204 for example. The switch module 206 and any additional controls 208 are electrically connected to a controller 210 which processes the switching or button presses to communicate signals to a wireless transmitter 212. The wireless transmitter 212 transmits signals to the associated devices to control functionality including turn signal, hazard lights, horn honks and the like.

According to various embodiments, the core controls drivers within the combination switch module 200 encompass the hardware and software components responsible for translating the driver's physical actions into electrical signals that initiate the turn signaling sequence. These drivers can include the following elements:

Lever Actuation Mechanism: This is the physical linkage between the lever 204 and the switch module 206. It's responsible for converting the mechanical movement of the lever (left, right, up, down) into a distinct electrical signal. This mechanism can include detents or tactile feedback to provide a clear indication to the driver that the switch has been engaged.

Switch Module (206): This module houses the electrical components (e.g., contacts, resistors, sensors) that detect the position of the lever. It generates distinct electrical signals corresponding to each lever position (left turn, right turn, lane change tap, etc.). These signals are then passed to the controller 210.

Additional Controls (208) Interface: If present, this component manages the input from additional controls such as a hazard light button or a horn button. It translates the button presses into corresponding electrical signals for the controller 210.

Controller (210) Input Processing: The controller 210 receives the raw electrical signals from the switch module 206 and additional controls 208. It processes these signals to:

Signal Debounce: Filters out spurious signals caused by contact bounce in the mechanical switches.

Interpret Lever Position: Determines the intended action based on the lever position and any additional inputs (e.g., a short tap for a lane change vs. a full deflection for a turn).

Self-Cancellation Logic/Management: Implements the automatic turn signal cancellation feature, potentially using a timer or input from other vehicle systems (e.g., wheel speed sensors).

Wireless Command Formulation: Creates a data packet containing the appropriate command to be transmitted to the remote light modules.

Wireless Transmitter (212) Activation: The controller 210 activates the wireless transmitter 212 to transmit the command packet to the remote light modules. This involves encoding the data, modulating the signal, and transmitting it over the air using the selected wireless protocol (e.g., Wi-Fi).

These core controls drivers work in concert to provide a reliable and intuitive interface for the driver to control the turn signaling system.

One or more status indicators 214 may be present according to various embodiments, to indicate system state (e.g. active turn signals, hazards, or other functionality). The module 200 may use power from a vehicle's battery or other available power source. The modular wireless design of the module 200 simplifies installation and allows for expandable functionality. The controller 210 may be a microcontroller or similar circuitry and may receive software updates. In some embodiments, the wireless transmitter is a transceiver and may receive communication from other devices or receive software updates for the controller 210 over the air.

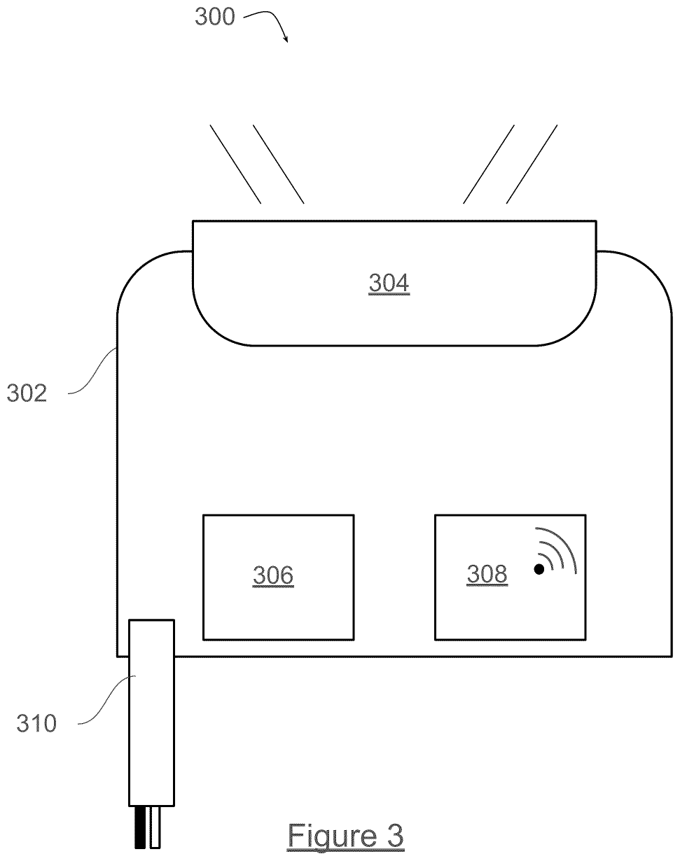

FIG. 3 illustrates a remote module 300 which communicates with a combination switch (for example as illustrated in FIG. 2) to perform one or more functions. The module 300 includes a housing 302. The housing 302 generally encases a light 304, a control module 306, a wireless receiver 308 and a power connection 310. The light 304 may be a single light or multiple light components which may operate together or independently (e.g. high/low beams, amber/red lights . . . ). According to various embodiments, the light 304 may not be encased in the housing 302, but may have an electrical connection from the housing 302, allowing the housing 302 to be mounted away from the light 304. The light 304 derives power from the power connection 310 which is connected to a vehicle's battery or other power supply. Power from the power connection is regulated and controlled by the control module 306. The control module 306 may control operation of the light 304 (or multiple lights according to other embodiments), or other functionality present in the remote module 300. The control module 306 receives signals from the wireless receiver 308, which in turn receives signals from a wireless transmitter to control the operation of the light 304. According to some embodiments the wireless receiver 308 is a wireless transceiver, able to both transmit and receive wireless signals. Transmitted signals may include handshakes, acknowledgement, status indication, sensor data communication or other communication.

The wireless receiver 308 picks up the signals transmitted from a combination switch and passes them to the control module 306. The control module 306 then executes programmed lighting logic and controls the light 304 appropriately. In this way, e left or right turn signals, hazards, and/or the brake lights may be controlled. The power connection 301 provides steady voltage to the lights from a DC power source on the vehicle. This modular wireless architecture allows the remote module 300 to be quickly installed anywhere on the vehicle exterior without running control wires. Capabilities and functionality can also be enhanced over time via software updates to the control module 306.

According to additional embodiments, the remote module 300 may include an external connection in addition to or instead of the light 304. In this way, an additional device external to the remote module 300 may be connected and controlled by the remote module 300. An example of this embodiment may be a trailer wiring harness. A trailer may be hitched to a vehicle and the remote module 300 would include a connector to allow trailer light wiring to be connected. The remote module 300, in communication with a driver-controlled combination switch would then have the capability to control turn signals and brake lights on the trailer. Additional functionality is also considered, including off-road lighting, fog lighting, utility lighting, horns/sirens and the like.

In certain embodiments, the wireless receiver 308 within the remote module 300 is further configured to facilitate communication with other vehicle systems beyond the core turn signal functionality. The control module 306 is adapted to receive signals from these other vehicle systems, enabling the integration of additional functionalities into the programmed lighting logic. For example, the control module 306 may receive a signal from the vehicle's braking system, causing the light 304 to activate additional brake lights or flash the existing brake lights rapidly to provide an enhanced emergency braking alert to following vehicles. As another example, the control module can receive signals from the vehicle's GPS system, allowing the turn signals to automatically activate when approaching a pre-programmed intersection, or from the vehicle's headlights, automatically adjusting the brightness of the turn signals. This capability allows for a more integrated and intelligent vehicle lighting system, enhancing safety and convenience for the driver.

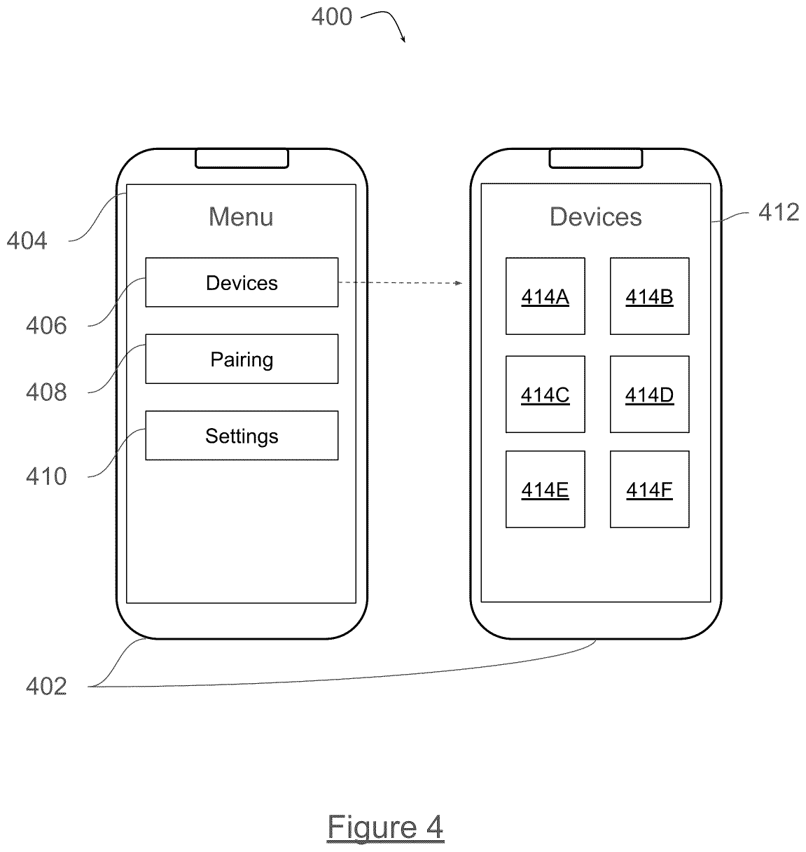

FIG. 4 illustrates a companion app 400 used to provide configuration and functionality adjustment for customizing and managing a remote module platform. The app 400 could be a mobile app, web application, or computer desktop application and would connect to any module (combination switch, remote modules . . . ) wirelessly using one or more communication protocols—e.g. Bluetooth, WiFi, Zigbee, ZWave, LoRaWAN or others. Within the app 400, on a mobile device 402, a user would be presented with a menu 404 used to configure settings. The menu 404 may include an option to manage devices 406, an option to add devices 408, and a settings menu 410. Other menu items are considered as well.

Adding or pairing devices using the option to add devices 408 would entail bringing the mobile device 402 within wireless range of the remote module to be added and stepping through a pairing process. This may include powering up the remote module and putting it into pairing mode while the mobile device 402 identifies the remote module and adds it to the list of devices under management. The settings menu 410 may include account settings, software version information, wireless communication settings and the like.

The option to manage devices 406 can bring the user to another screen with a devices menu 412. In this view, each device may be shown to allow the user to configure, identify and confirm connection with remote modules. The remote modules can be shown in this menu as remote module items 414A-F. These remote module items 414A-F may include an indication of connection and/or operational status and may include a label description and/or pictorial representation of the remote module. The remote modules may include signal lights, combination switch, trailer connections, horns, utility lights and other modules operable on the platform. Selecting a remote module item 414A-F will allow the user to configure any settings available for that remote module. For example, these configurations may include turn signal timing, sequence and brightness of lights, light colors, and horn or other audio sounds. As an example, various different horn sounds like (e.g. truck air horns . . . ) can be selected or configured through the settings app.

The app 400 can also show diagnostic information from the combination switch and other remote modules, such as wireless signal strength, power status, and component health metrics. Diagnostic issues may trigger alert notifications to the user. Additionally, the app 400 could be used to update modules firmware, enabling new capabilities and fixes. The app 400 would provide a user-friendly interface to personalize the system and keep it running optimally. The wireless connectivity between app 400, combination switch, and other remote modules enables a cohesive connected platform.

According to various alternative embodiments, the modular wireless design disclosed herein is adapted for use on other vehicles and equipment such as boats, heavy equipment (e.g. bulldozers or cranes, tractors, commercial trucks, or other specialized vehicles) which may need or be benefitted by the addition of turn signals.

According to other embodiments, additional lighting options can be included in the inventive system. For example, the addition or integration of reverse lights is included. The rear light modules can be adapted to include integrated reverse lights that activate when the vehicle is put into reverse gear or operational mode. Similarly, a third brake light can be included within the inventive system as well. An additional light module can be mounted, for example, on a cab roof to provide a high-mounted third brake light. According to other embodiments, forward facing light modules can have the option to operate as extra auxiliary lighting when not being used as turn indicators. In yet other example embodiments, inclusion of integrated headlight control is considered. In these examples, the combination switch can be expanded to allow wireless control of headlights in addition to signals.

According to other embodiments, a trailer wiring module is included. In these embodiments, a wireless module can provide connectivity via, for example, standard trailer electrical connectors, to trailer lights to allow seamless integration of trailer turn/brake signaling.

The modular architecture allows for a wide range of optional capabilities to be added over time to expand the system's functionality.

Embodiments of the invention described in the above paragraphs and examples may be applied for (without limitation) ATVs, UTVs, golf carts, other utility vehicles, trailers, existing vehicles (retrofit), new vehicle manufacturing, off-road vehicles, vehicles requiring temporary lighting, and vehicles with limited wiring access.

Thus, example embodiments of the inventive subject matter are disclosed. One skilled in the art will appreciate that the present teachings can be practiced with embodiments other than those disclosed. The disclosed embodiments are presented for purposes of illustration and not limitation, and the present teachings are limited only by the claims that follow.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

What is claimed is:

1. A signaling system for a vehicle, comprising:
a combination switch module including a user-actuated lever for signaling a turn and a wireless transmitter configured to transmit a control signal in response to actuation of the user-actuated lever; and
at least one remote light module including:
a housing;
a light source disposed within the housing;
a wireless receiver configured to receive the control signal from the combination switch module; and
a control module, coupled to the light source and the wireless receiver, the control module configured to activate the light source in response to the received control signal;
the control module further configured to receive over-the-air (OTA) software updates for modifying the behavior of the remote light module;
wherein the signaling system is installed without a wired harness connecting the combination switch module and the one remote light module.

2. The signaling system of claim 1, wherein the combination switch module has a multi-position lever interface to activate left, right, or hazard turn signaling.

3. The signaling system of claim 1, wherein the light modules are configured to mount on exterior vehicle surfaces including the front, rear, and sides.

4. The signaling system of claim 1, further comprising a wireless configuration and diagnostic module to allow parameter adjustment and monitoring of combination switch module and light modules.

5. The signaling system of claim 4, wherein the wireless configuration and diagnostic module is a mobile computing device running an associated application.

6. The signaling system of claim 1, further comprising one or more auxiliary wireless modules interfacing with combination switch module to provide additional capabilities.

7. The signaling system of claim 6, wherein the auxiliary wireless modules are selected from trailer wiring harnesses, reverse lights, cargo lamps, or warning beacons.

8. The signaling system of claim 1, wherein the light module comprises multiple light components capable of operating independently, and the control module is configured to control the operation of each light component individually based on signals received from the wireless receiver.

9. A modular turn signal system for a vehicle, comprising:
a combination switch module including:
a lever for selecting a turn direction;
a wireless transmitter for sending turn signal commands; and
a one or more remote light modules, each including:
a housing adapted for mounting on the vehicle;
a light;
a wireless receiver for receiving turn signal commands from the combination switch module; and
a control module configured to control the light based on the received turn signal commands; and
a mobile application installed on a user device configured to wirelessly communicate with the combination switch module and the plurality of remote light modules to:
configure settings for each of the remote light modules;
add or remove remote light modules from the system; and
display a status of each of the remote light modules,
wherein the mobile application provides an interface to manage devices, add devices, and adjust system settings.

10. The modular turn signal system of claim 9, wherein the remote light modules are powered from a power source on the vehicle.

11. The modular turn signal system of claim 9, wherein the remote light modules are not in wired communication with the combination switch module.

12. The modular turn signal system of claim 9, wherein one or more of the remote light module comprises multiple lights capable of operating independently, and the control module is configured to control the operation of each light individually based on signals received from the wireless receiver.

13. The modular turn signal system of claim 9, wherein the wireless receiver further facilitates communication with other vehicle systems, wherein the control module is adapted to receive signals from said other vehicle systems for integrating additional functionalities into the programmed lighting logic.

14. The modular turn signal system of claim 9, wherein the wireless receiver is configured to communicate with the mobile application, allowing software updates for enhancing capabilities and functionality of the control module.

15. The modular turn signal system of claim 9, wherein the light assembly is connected to the remote module via a wire connection and is mounted separately from the remote module.

16. The modular turn signal system of claim 9, wherein the wireless transmitter and the wireless receiver utilize a wireless communication protocol selected from the group consisting of: Bluetooth, Zigbee, ZWave, LoRaWAN, and WiFi.

17. A turn signal system for a utility vehicle, comprising:
a combination switch module including:
a user-actuated switch for signaling a turn;
a wireless transmitter configured to transmit a control signal in response to actuation of the user-actuated lever, wherein the wireless transmitter utilizes a Wi-Fi communication protocol; and
at least one remote light module including:
a housing;
an LED light source disposed within the housing;
a wireless receiver configured to receive the control signal from the combination switch module, wherein the wireless receiver utilizes a Wi-Fi communication protocol; and
a control module, coupled to the LED light source and the wireless receiver, the control module configured to activate the LED light source in response to the received control signal;
wherein the turn signal system is installed without a wired harness connecting the combination switch module and the at least one remote light module.

18. The turn signal system of claim 17, wherein the combination switch module further includes a controller adapted to receive software updates wirelessly to modify functionality of the user-actuated switch.

19. The turn signal system of claim 17, further comprising a mobile application configured to wirelessly communicate with the combination switch module and the at least one remote light module to configure settings or perform diagnostic checks, wherein the mobile application is configured to display an operational status of each of the at least one remote light module.

20. The turn signal system of claim 17, wherein the combination switch module includes at least one status indicator configured to visually indicate the operational state of the turn signal system, the at least one status indicator selected from the group consisting of: an active turn signal indication, a hazard light indication, and a system fault indication.
